(19) United States
(12) Patent Application Publication
(10) Pub. No.: US 2008/0028071 A1
(43) Pub. Date: Jan. 31, 2008

(54) Communication load reducing method and computer system

(75) Inventor: Hiroaki Miyajima, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/878,427

(22) Filed: Jul. 24, 2007

(30) Foreign Application Priority Data
Jul. 25, 2006 (JP) 2006-201995

(51) Int. Cl. G06F 15/173; G06F 15/16

(52) U.S. Cl. 709/224; 709/245

(57) ABSTRACT

A computer system connected to a network includes a terminal apparatus configured to detect an access destination on the network, acquire a destination data of the access destination, and generate a frame having the destination data for the access destination; and a monitoring apparatus configured to hold the destination data, and to produce at least one unicast frame to the access destination based on the destination data of the frame received from the terminal apparatus. The monitoring apparatus issues an access destination registration request to the terminal apparatus, and acquires the destination data from the terminal apparatus. The terminal apparatus holds a data indicative of reception of the access destination registration request from the monitor apparatus and notifies the destination data to the monitoring apparatus if the data indicative of the reception of the access destination registration request is stored when receiving a reply from the access destination.

### TECHNICAL FIELD

The present invention relates to a computer system, and more particularly relates to a technique for suppressing transmission of a frame from a terminal in a computer system.

### BACKGROUND ART

In an environment in which virtual machines (VMs) are used to integrate a plurality of clients, an IP address is considered to be set by using a service of a DHCP (Dynamic Host Configuration Protocol) system as one of client server systems in many cases. A virtual NIC (Network Interface Card) is assigned to each client, and this is connected through a physical NIC to LAN.

When the DHCP server is provided on a same machine (hyper-visor) as an integrated client by using one virtual machine, it is wasteful in a network band to broadcast a DHCP request from the client of the virtual machine on the same hyper-visor. Also, there is a possibility that the DHCP server in this case is used from other than the hyper-visor environment, or the client of the virtual machine on the hyper-visor reversely obtains the IP address from a different DHCP server.

When a communication destination is not known in advance in an inquiry of a network, the inquiry is simultaneously broadcasted. This will be further described below by exemplifying the DHCP. An IP address of a node is manually set to each node by a network manager in a case and is automatically set in another case. However, a protocol referred to as the DHCP was considered as a mechanism in the latter case. A method of using the broadcast under the DHCP will be described below in accordance with the definition of RFC2131. It should be noted that RFC (Request For Comment) is a document that is normally issued by the institution that defines the technical standard with regard to the Internet. There are published the specification and requirement of the protocol that is used in the Internet such as IP (RFC791), TCP (RFC793), HTTP (RFC2616) and FTP (RFC959), and the other various techniques with regard to the Internet, under the serial numbers.

In the DHCP, a specified DHCP server dynamically assigns a network address and transmits it to a host together with a configuration parameter. In the DHCP, a same message as BOOTP defined in the RFC951 is used. In the message that is sent to the DHCP server from the DHCP client who receives a configuration data from the DHCP server, an “Operation Code” is defined as BOOT_REQUEST, and in the message that is sent to the DHCP client from the DHCP server, it is defined as BOOT_REPLY.

FIG. 1 exemplifies several DHCP messages. In the DHCP, the DHCP client broadcasts DHCP_DISCOVER, DHCP_REQUEST and DHCP_PINFORM, if this does not know the address of the DHCP server.

As an example, flows of the DHCP_DISCOVER and the DHCP_REQUEST will be described below with reference to FIG. 2.

### (1) Step S1

At first, the DHCP client broadcasts the DHCP_DISCOVER to a local subnet.

### (2) Step S2, Step S2′

The DHCP server receives the DHCP_DISCOVER and responds DHCP_OFFER including “Assigned IP Address” and other options.

### (3) Step S3

The DHCP client waits until receiving one or more DHCP_OFFERs from a plurality of DHCP servers.

### (4) Step S4

When receiving one or more DHCP_OFFERs from the plurality of DHCP servers, the DHCP client checks the configuration data in the DHCP_OFFERs and selects any one DHCP server in accordance with the check result.

### (5) Step S5

The DHCP client broadcasts the DHCP_REQUEST that includes “Sever ID” to indicate that the DHCP server is selected. The DHCP server receives the DHCP_REQUEST broadcasted by the DHCP client. However, the DHCP server that is not specified by “Sever ID” recognizes that the DHCP client selects a different DHCP server on the basis of the DHCP_REQUEST.

### (6) Step S6

The specified DHCP server prepares a resource and carries out an answer, including the configuration data requested for DHCPACK. When receiving the DHCP_ACK including the requested configuration data, the DHCP client checks a parameter (checks the network address assigned in ARP) and records a lease period and the like. This implies the completion of the configuration of the DHCP client.

The transmission/reception of DHCP_INFORM will be described below. When obtaining the network address by using a method other than the DHCP, the DHCP client broadcasts the DHCP_INFORM in order to obtain the other local parameters. The DHCP server receives the DHCP_INFORM message and responds a DHCP_ACK in which a local parameter suitable for the DHCP client is included, without setting of address assignment, check of the existing lease and settings “Assigned IP Address” and “Lease Period”. The DHCP server directly transmits the DHCP_ACK message to “Client IP Address” of the DHCP_INFORM.

A broadcasting process in ARP (Address Resolution Protocol) will be described below with reference to FIG. 3. The ARP is a protocol used to determine a physical address (MAC address) of Ethernet (a registered trademark) from the IP address in a TCP/IP network. The ARP is defined in accordance with RFC826. It should be noted that the MAC (Media Access Control) address is an ID number peculiar to a communication interface (NIC).

### (1) Step S11

When desired to know the MAC address of a host having the IP address of “IP Address 1”, the host 1 on a network uses the ARP and transmits a broadcast packet.

### (2) Step S12

The host 1 waits until reception of a response from the ARP.

### (3) Step S13

Each of hosts receiving this broadcast packet checks whether or not its own IP address is coincident with the transmitted IP address 1.

### (4) Step S14

The host having the IP address coincident with the “IP address 1” replies its own MAC address to the host 1. Here, since a host 2 coincides with the “IP address 1”, the host 2 replies its own MAC address to the host 1.

The above broadcast imposes a heavy load on a local area network. The packet itself is distributed by a unicast or broadcast to all of the computers sharing the Ethernet. However, if a network switch is used, the unicast packet can be filtered by the network switch. The unicast packet other than packets destined to the computer having a specified destination MAC address is processed in a NIC, and the packet is not sent to a higher hierarchy. However, a broadcast packet cannot be processed in the NIC, and is sent to a higher hierarchy. Then, the packet is processed in an OS or application in that computer. Thus, a computer resource is uselessly used.

Such problems become remarkable in a virtual machine in which generations and removals are frequently executed. When the virtual machine is generated and the assignment of the IP address is newly determined in the above DHCP system, the virtual machine broadcasts an inquiry packet because the location of the DHCP client is not known. Thus, the packet is sent to a network layer of a different computer connected to the network, and a CPU resource is exhausted, to determine the fact that the packet is not destined to itself. This process has influence on the other processes on the computer. However, on the physical machine in which the virtual machine is generated, there is a case that a different virtual machine is already generated and started, and the location of the DHCP server can be already grasped through the broadcast of the different virtual machine. In this way, when the plurality of virtual machines may be generated on a certain host (physical machine) on the network, the address of the DHCP server can be known from the virtual machine that has been previously generated and started. Therefore, the broadcast executed by the virtual machine that is generated and started with a delay on the host is redundant.

Similarly, a case in which the MAC address is queried in the ARP is similar. When the MAC address of the host corresponding to an IP address is already obtained by the virtual machine on the physical machine, the broadcast of an inquiry for conversion from a different MAC address to the same IP address on the same physical machine is redundant.

As a related technique, Japanese Laid Open Patent Application (JP-P2000-59387A) describes a technique in which only a particular DHCP server transmits a DHCP_OFFER message to a DHCP_DISCOVER message from a DHCP client. The DHCP client broadcasts the DHCP_DISCOVER message. Then, each DHCP server receives this message and determines whether or not the DHCP client is its own management target host. If it is not the management target host, the DHCP_DISCOVER message is discarded. If it is the management target host, the DHCP_OFFER is broadcasted. The DHCP client transmits a DHCP_REQUEST message to the DHCP server replying a response through unicast.

Japanese Laid Open Patent Application (JP-P2004-104199A) describes load dispersion of the DHCP server. When a plurality of DHCP servers are provided in the same local area network, the DHCP server that firstly treats with the data is selected in many cases. Thus, there is a case that the heavy load is imposed on a particular DHCP server. In order to solve this, the DHCP client holds the pre-registered IP address on the DHCP server and requests the DHCP server having the IP address, which is coincident with the held IP address, to obtain the network parameter.

Japanese Laid Open Patent Application (JP-P2001-230788A) describes a configuration in which in order to provide against a problem in the DHCP server, a plurality of DHCP servers exist in the local area network, and they hold the same IP address pool.

However, all of the above-mentioned related arts do not disclose a device for suppressing broadcast.

In Japanese Laid Open Patent Application (JP-P2000-59387A), the DHCP_DISCOVER message and DHCP_OFFER message are broadcasted. In Japanese Laid Open Patent Application (JP-P2004-104199A), when the IP address of the DHCP client is not still defined immediately after a start, the broadcast is used in accordance with a normal procedure. Even in Japanese Laid Open Patent Application (JP-P2001-230788A), nothing is described about the suppression of the broadcast.

### SUMMARY

It is therefore an exemplary object of the present invention to provide a computer system in which generation of frames for a processing request can be suppressed under a virtual machine (VM) environment.

Another exemplary object of the present invention is to provide a computer system in which increase in a load of a network can be suppressed.

Still another exemplary object of the present invention is to provide a computer system in which a DHCP address acquiring request in a local broadcast is not broadcasted on a hyper-visor, and is used as a unicast to a DHCP server.

Still another exemplary object of the present invention is to provide a computer system in which after completion of setting of an IP address, its client is connected to LAN.

In an exemplary aspect of the present invention, a computer system connected to a network, includes a terminal apparatus configured to detect an access destination on the network, acquire a destination data of the access destination, and generate a frame having the destination data for the access destination; and a monitoring apparatus configured to hold the destination data, and to produce at least one unicast frame to the access destination based on the destination data of the frame received from the terminal apparatus. The monitoring apparatus issues an access destination registration request to the terminal apparatus, and acquires the destination data from the terminal apparatus. The terminal apparatus holds a data indicative of reception of the access destination registration request from the monitor apparatus and notifies the destination data to the monitoring apparatus if the data indicative of the reception of the access destination registration request is stored when receiving a reply from the access destination.

In another exemplary aspect of the present invention, a method of reducing a communication load, includes acquiring a frame and confirming whether or not the frame is a predetermined message; confirming whether or not address data of a server has been stored as an access destination address when the frame is the predetermined message; rewriting a destination address of the frame by the address data of the server when the address data of the server is stored; and starting an access destination registration requesting process when the address data of the server has not been stored as the access destination address.

In still another exemplary aspect, the present invention is related with a computer-readable software product for realizing a method of reducing a communication load. The method includes acquiring a frame and confirming whether or not the frame is a predetermined message; confirming whether or not address data of a server has been stored as an access destination address when the frame is the predetermined message; rewriting a destination address of the frame by the address data of the server when the address data of the server is stored; and starting an access destination registration requesting process when the address data of the server has not been stored as the access destination address.

### BRIEF DESCRIPTION OF DRAWINGS

The above and other objects, advantages and features of the present invention will be more apparent from the following description of exemplary embodiments taken in conjunction with the accompanying drawings, in which:

FIG. 1 is an example of a DHCP message;

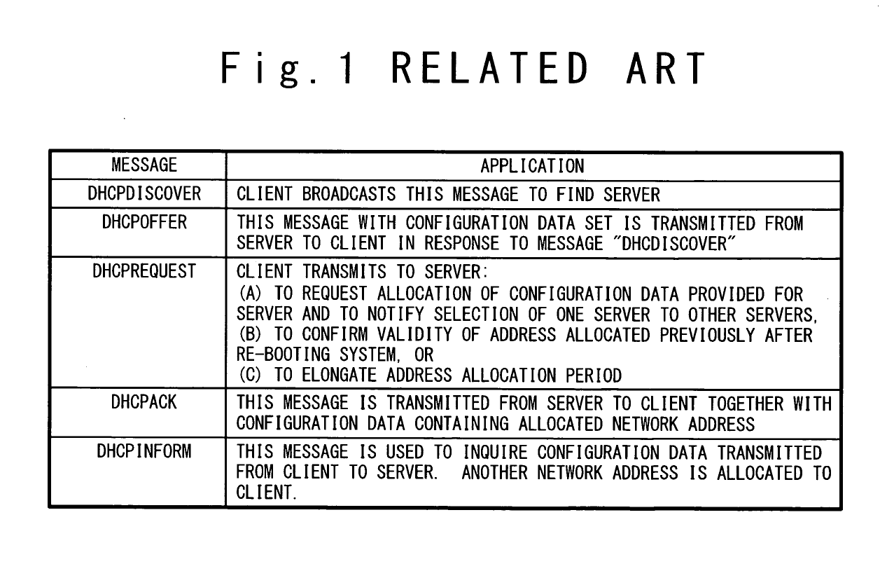

FIG. 2 is a flowchart of a DHCP requesting process;

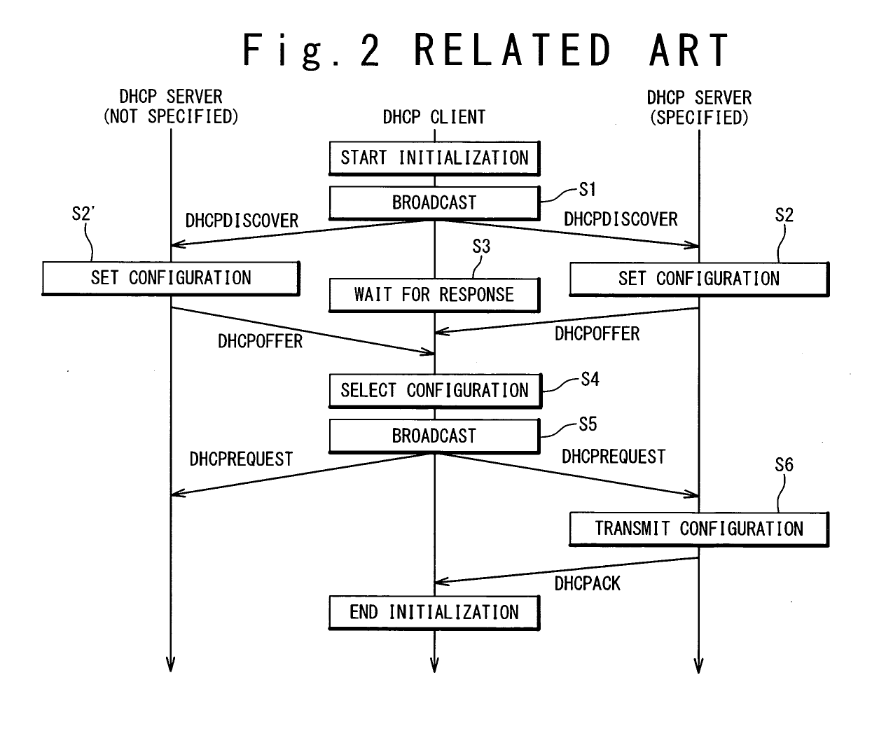

FIG. 3 is a flowchart of a broadcasting process in ARP;

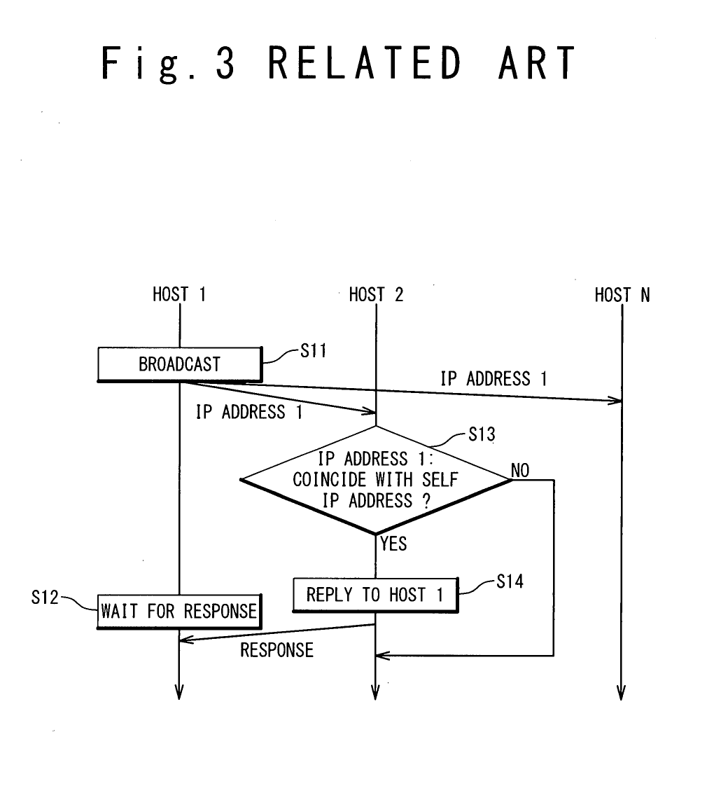

FIG. 4 is a block diagram showing a configuration of a server system as a computer system of the present invention;

FIG. 5 is a diagram showing an example of a format of a frame;

FIG. 6 is a block diagram showing an operation example when the frame is sent to a communication path;

FIG. 7 is a block diagram showing an operation example when it is directly sent to a virtual machine having a destination address;

FIG. 8 is a flowchart showing an operation of the server system according to a first exemplary embodiment of the present invention;

FIG. 9 is a flowchart showing an example of a DHCP message format;

FIG. 10 is a flowchart of an access destination registration requesting process;

FIG. 11 is a diagram showing an example of a second access destination storage section of the present invention;

FIG. 12 is a flowchart showing an operation of the server system according to a second exemplary embodiment of the present invention;

FIG. 13 is a diagram showing an example of a third access destination storage section of the present invention;

FIG. 14 is a flowchart showing an operation of the server system according to a third exemplary embodiment of the present invention;

FIG. 15 is a diagram showing an example of a fourth access destination storage section of the present invention;

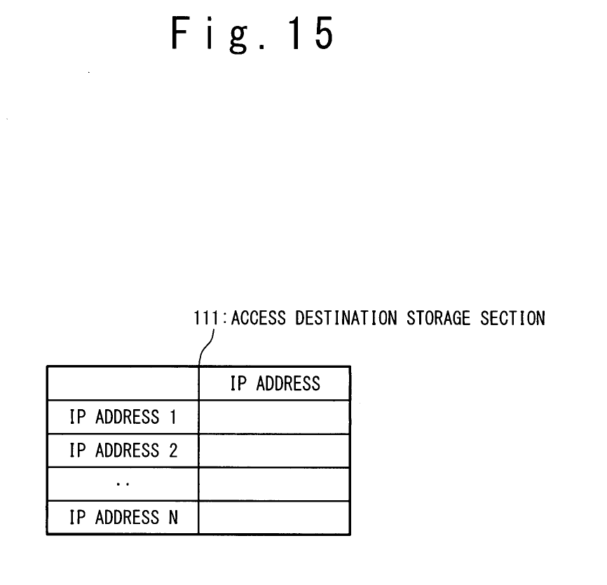

FIG. 16 is a flowchart showing an operation of the server system according to a fourth exemplary embodiment of the present invention;

FIG. 17 is a flowchart of an access destination registration requesting process;

FIG. 18 is a diagram showing an example of a fifth access destination storage section of the present invention;

FIG. 19 is a flowchart showing an operation of the server system according to a fifth exemplary embodiment of the present invention; and

FIG. 20 is a block diagram showing a configuration of the server system according to a sixth exemplary embodiment of the present invention.

### EXEMPLARY EMBODIMENTS

Hereinafter, a computer system according to exemplary embodiments of the present invention will be described in detail with reference to attached drawings.

### First Exemplary Embodiment

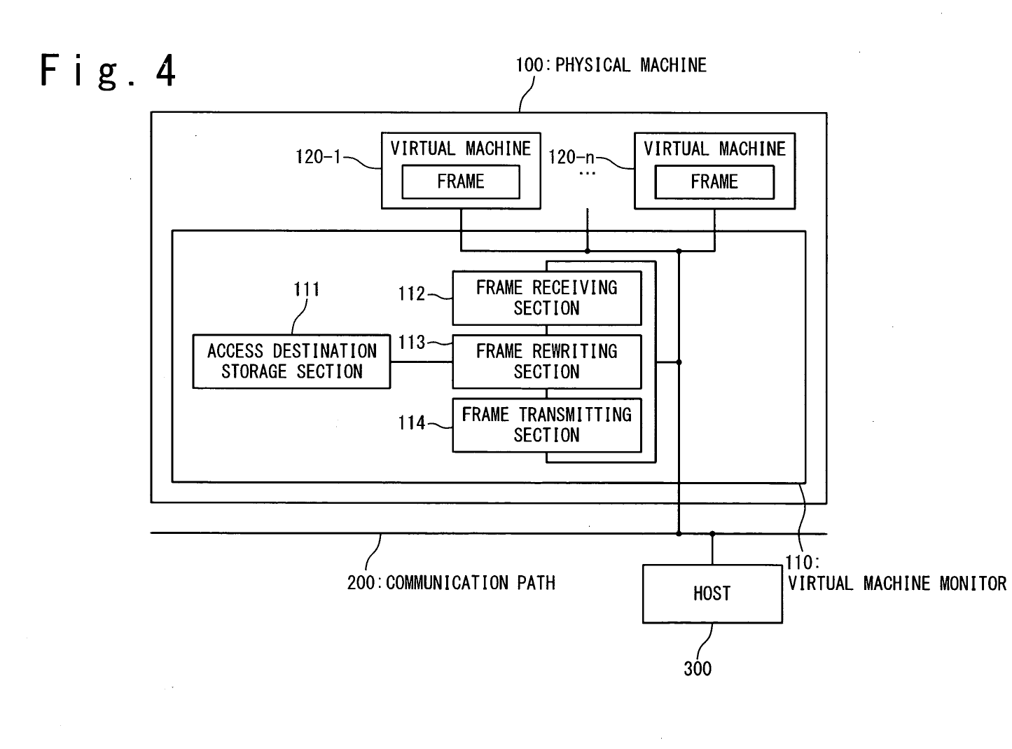

FIG. 4 is a block diagram showing a configuration of the computer system according to a first exemplary embodiment of the present invention. With reference to FIG. 4, the computer system according to the first exemplary embodiment of the present invention contains a physical machine 100, a communication path 200 and a host 300. The physical machine 100 contains a virtual machine monitor 110 and virtual machines 120 (120-k, k=1 to n: n is the number of the virtual machines). The virtual machine monitor 110 and the virtual machine 120 operate on the physical machine 100. The virtual machine monitor 110 may be a configuration referred to as VMM (Virtual Machine Monitor) or a hyper-visor. The virtual machine 120 is VM (Virtual Machine) that is generated and started by the physical machine 100. The communication path 200 is a network for supporting a broadcast communication such as Ethernet (Registered Trademark).

It should be noted that the virtual machine monitor 110 and the virtual machines 120 may be the programs that are executed by the individual processing units (CPUs, not shown), respectively. At this time, a data communication may be carried out between the processing unit operating as the virtual machine monitor 110 and the processing unit operating as the virtual machine 120.

The virtual machine monitor 110 includes an access destination storage section 111, a frame receiving section 112, a frame rewriting section 113 and a frame transmitting section 114. The access destination storage section 111 stores an address of a host for carrying out a predetermined process. The frame receiving section 112 receives frames transmitted from the virtual machines 120. It should be noted that the frame implies a data of a data format used in a particular protocol. Usually, this is a packet in a data link layer, and includes a transmission source address and a transmission destination address. The frame rewriting section 113 rewrites the destination address of the frame in accordance with a data stored in the access destination storage section 111. The frame transmitting section 114 transmits the frame. Here, as the predetermined process, there is a process for carrying out an inquiry on the network through broadcast as well as DHCP (Dynamic Host Configuration Protocol). This will be described below by exemplifying DHCP. Also, the communication path 200 will be described below by exemplifying Ethernet.

The access destination storage section 111 includes a memory. Also, this may include a disk. The access destination storage section 111 stores an address of the DHCP server. It is supposed that as the address of the DHCP server, the IP address and a MAC address are both stored. These data are obtained from the virtual machine that operates as a DHCP client on the physical machine 100 and obtains the address of the DHCP server. It should be noted that the access destination storage section 111 may store only the IP address as the address of the DHCP server, and the MAC address corresponding thereto may be acquired from an ARP (Address Resolution Protocol) table.

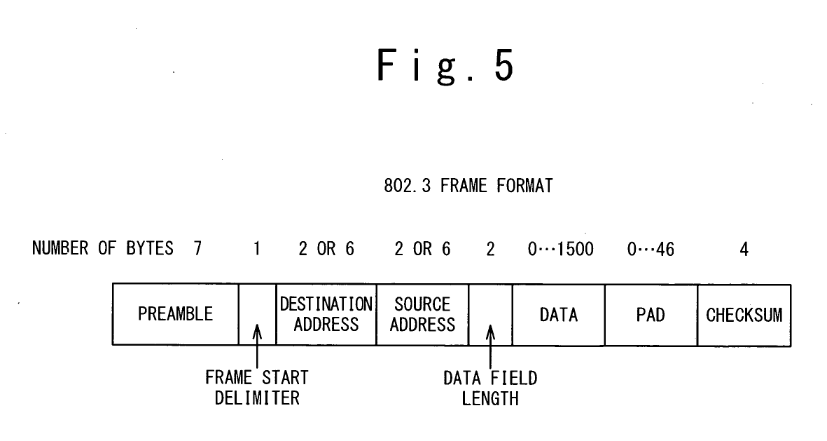

The frame receiving section 112 receives a broadcast frame from the virtual machine 120-1 operating as a DHCP client before it appears on the communication path 200. At this time, the frame receiving section 112 checks whether or not the received frame satisfies a predetermined condition. FIG. 5 shows the format of the frame in a CDMA/CD (Carrier Sense Multiple Access with Collision Detection) access control on the Ethernet. It should be noted that each of the transmission destination address and the transmission source address include the IP address and the MAC address.

If the frame received by the frame receiving section 112 satisfies the predetermined condition, the frame rewriting section 113 rewrites the destination address of this frame. It should be noted that the frame rewriting section 113 may determine whether or not the frame satisfies the predetermined condition.

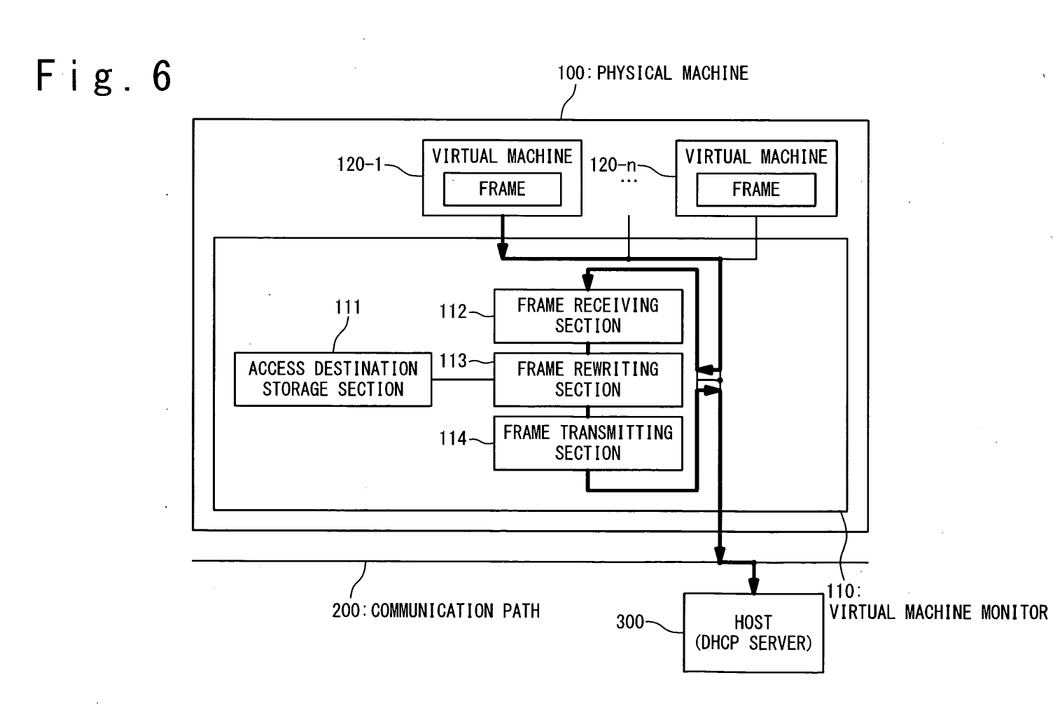

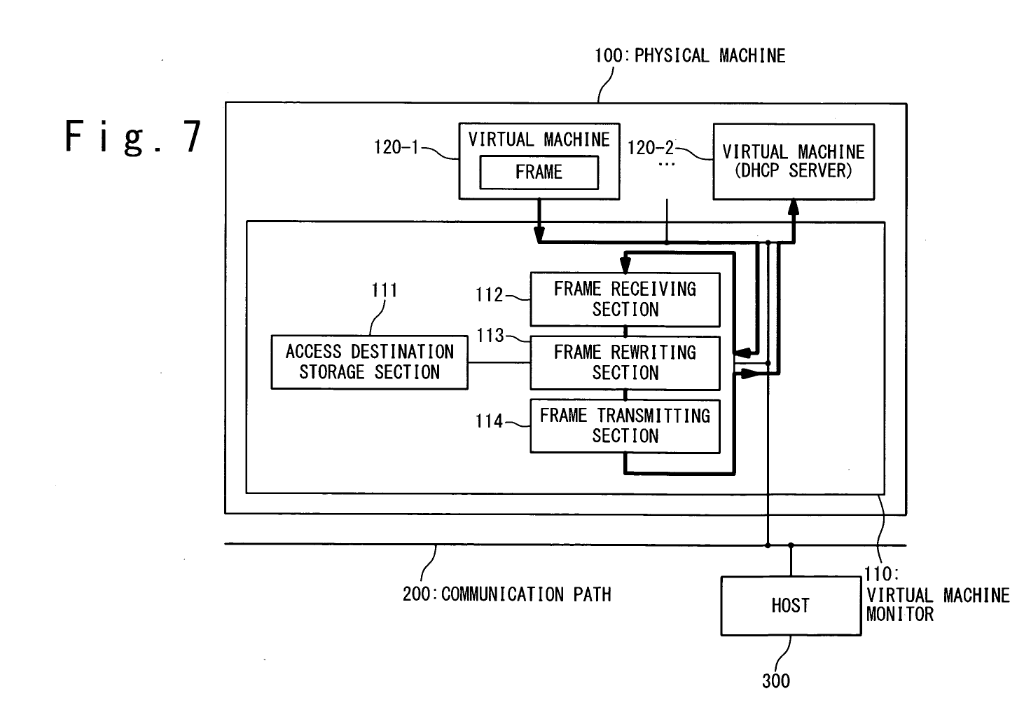

The frame transmitting section 114 transmits the frame to the destination address of the frame. If the destination address belongs to a host located on a network, the frame transmitting section 114 transmits the frame onto the communication path 200, as shown in FIG. 6. On the other hand, if the destination address located on the physical machine 100 to which the frame transmitting section 114 belongs, as shown in FIG. 7, the frame is directly transmitted to a virtual machine 120-2 having the destination address. Whether or not the destination address is located on the physical machine 100 to which the section itself belongs can be determined, for example, by comparing the MAC address of the destination address and the MAC address of the virtual machine 120 on the physical machine 100.

It should be noted that when the physical machine 100 is a typical computer, the frame is transmitted and received through a communication interface (NIC). The processing unit (CPU) carries out a determination and the other processes, and the storage section (a memory, a hard disk) stores the frame and the other information. That is, the frame receiving section 112 and the frame transmitting section 114 can be configured by a combination of the communication interface and the processing unit. The frame rewriting section 113 can be configured by the processing unit, and the access destination storage section 111 can be configured by the storage section. It should be noted that the communication between the virtual machine monitor 110 and the virtual machine 120 is an operation on the physical machine 100. Therefore, actually, there is a case that the communication interface (NIC) is not used and it may be performed such that a data of a frame format between the respective programs is transmitted and received.

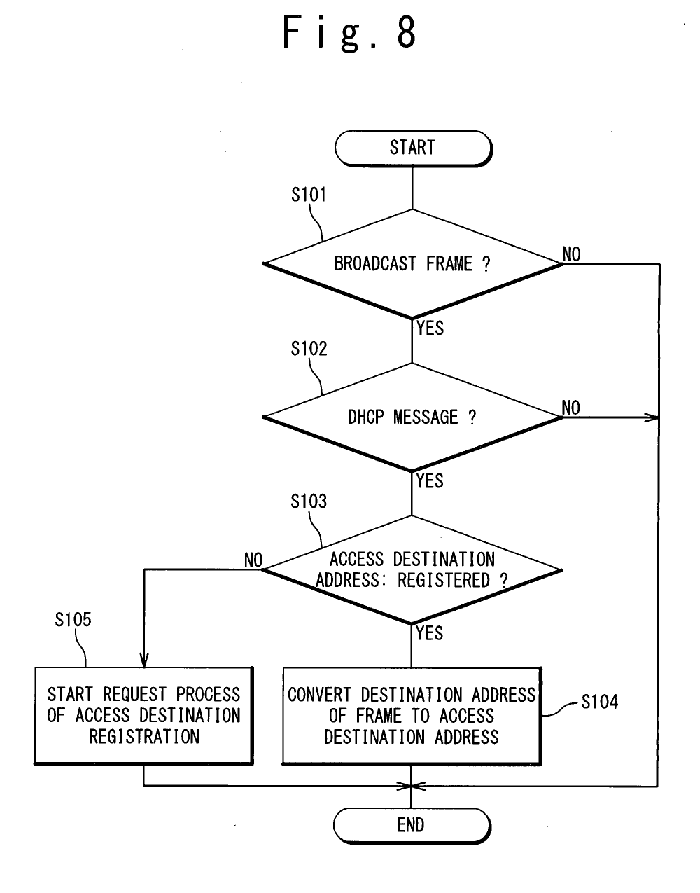

The operation of the computer system according to the first exemplary embodiment of the present invention will be described below in detail with reference to a flowchart of FIG. 8.

### (1) Step S101

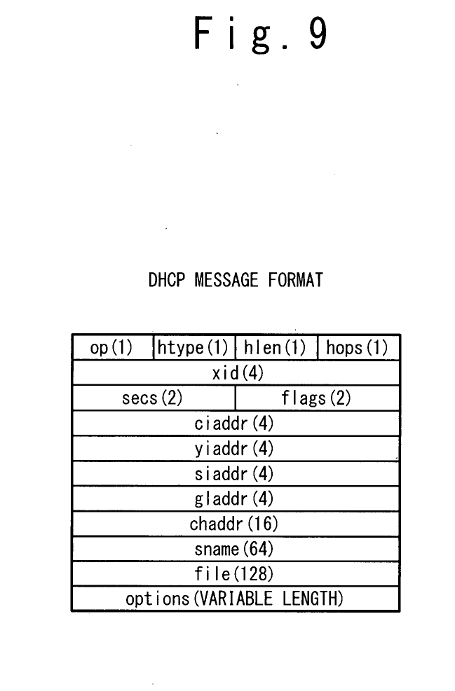

When the frame transmitted from the virtual machine 120-1 is received by the frame receiving section 112, the virtual machine monitor 110 checks whether or not the frame is a broadcast frame. This check is carried out by determining whether or not the transmission destination address of the frame is a broadcast address in a DHCP message format shown in FIG. 9.

### (2) Step S102

If this frame is the broadcast frame, the frame rewriting section 113 checks whether or not this frame is the DHCP message.

### (3) Step S103

If this frame is the DHCP message, the frame rewriting section 113 refers to the access destination storage section 111 and checks whether or not the address data of the DHCP server is stored as an access destination address.

### (4) Step S104

If the address data of the DHCP server is stored, the frame rewriting section 113 rewrites the transmission destination address of the DHCP frame in accordance with the stored address data of the DHCP server. At this time, a process of setting the MAC address of the DHCP server to an Ethernet header and setting the IP address of the DHCP server to the IP address is performed. Also, the other fields such as a checksum are rewritten as necessary.

### (5) Step S105

On the other hand, if the address data of the DHCP server as the access destination address is determined not to be stored, an access destination registration requesting process is started.

After the foregoing process, the frame is transmitted to the destination. Here, the checking order between the steps S101 and S103 may be properly changed to consideration of processing performance.

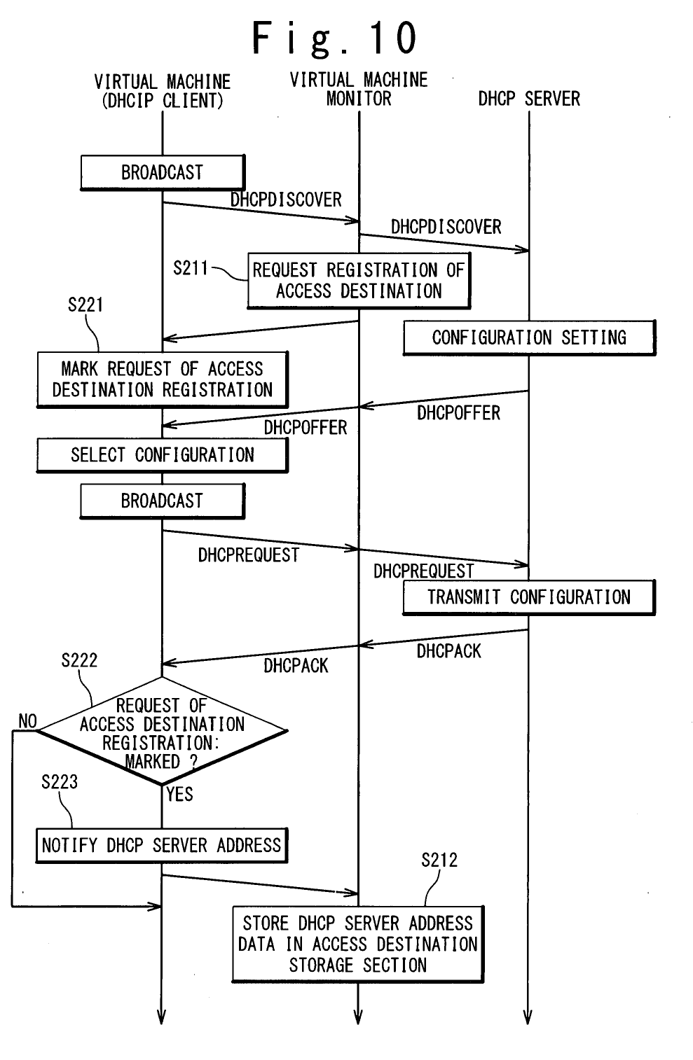

The flow of the access destination registration requesting process will be described below with reference to FIG. 10.

### (1) Step S211

When the access destination registration requesting process is started at the step S105 in FIG. 6, the virtual machine monitor 110 issues an access destination registration request to the virtual machine 120-1 requesting the broadcast from the DHCP.

### (2) Step S221

The virtual machine 120-1 receives the access destination registration request and marks the fact that the access destination registration request has been issued, i.e., holds or stores a data indicative of the reception of the request.

### (3) Step S222

Subsequently, the virtual machine 120-1 receives DHCPACK from the DHCP server and the DHCP server is determined. However, then, whether or not the data indicative of the access destination registration request is stored is checked.

### (4) Step S223

When it is marked, the address data (the MAC address, the IP address) of the determined DHCP server is notified to the virtual machine monitor 110.

### (5) Step S212

The virtual machine monitor 110 stores this address data in the access destination storage section 111. Here, a flow in which the virtual machine monitor 110 stores the address data in the access destination storage section 111 will be described. However, if the virtual machine 120-1 can access the access destination storage section 111, the virtual machine 120-1 may directly store the address data in the access destination storage section 111.

On the other hand, as shown in FIG. 7, if the virtual machine 120-2 operates as the DHCP server, the virtual machine 120-2 may register its own address data in the access destination storage section 111 when starting functions as the DHCP server. At the time of the registration, the registration request is issued to the virtual machine monitor 110, and the virtual machine monitor 110 may register it in response to the request. Also, when a virtual machine 120 can directly write the data into the access destination storage section 111, the virtual machine 123 may directly write it.

In the first exemplary embodiment of the present invention, the broadcast message is converted into a unicast message. Thus, the network load caused by the broadcast can be suppressed. Also, when the destination address of the message indicates the virtual machine 120-2 in the physical machine 100, the frame is not transmitted to the communication path 200. Therefore, this has no influence on the other nodes on the network. Moreover, since the frame is directly transmitted to the virtual machine 120-2 that operates as the DHCP server, the communication of a high speed can be attained.

### Second Exemplary Embodiment

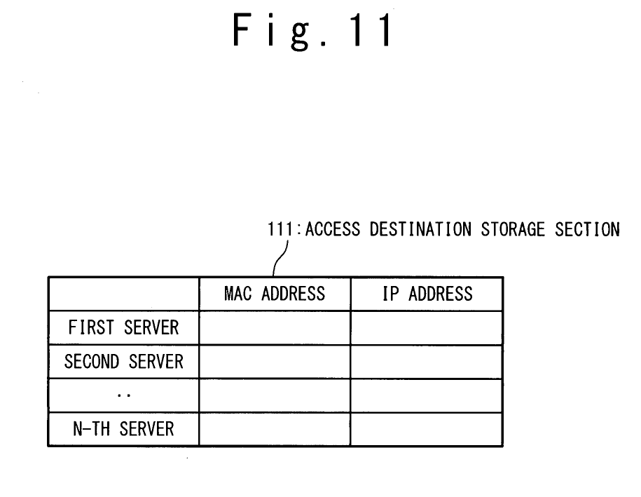

The configuration of the computer system according to a second exemplary embodiment of the present invention will be described below in detail with reference to the drawings. With reference to FIG. 11, in the configuration of the computer system according to the second exemplary embodiment of the present invention, a plurality of access destination server addresses can be stored as the access destination storage section 111 of FIG. 4.

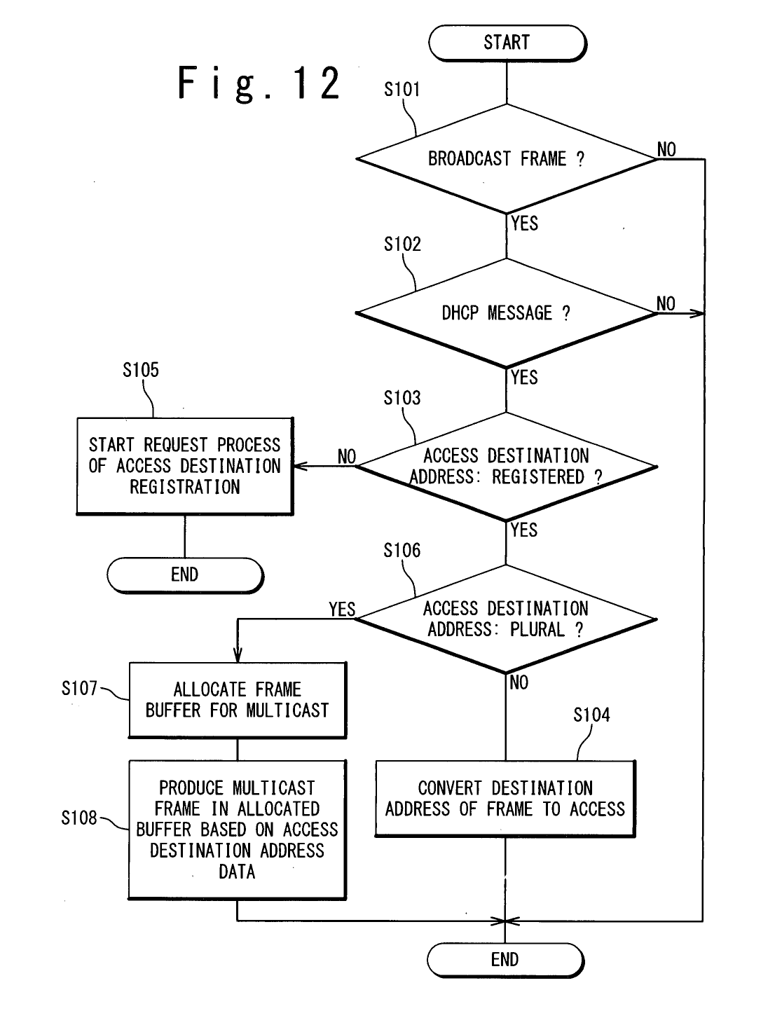

The operations of the computer system according to the second exemplary embodiment of the present invention will be described below in detail with reference to a flowchart of FIG. 12. In FIG. 12, steps S106 to S108 are added to the flowchart of FIG. 8. However, the other steps are same as those of FIG. 8.

### (1) Step S101

When a frame transmitted from the virtual machine 120-1 is received by the frame receiving section 112, whether or not the frame is the broadcast frame is checked. This check is carried out by determining whether or not the destination address is the broadcast address in the DHCP message format shown in FIG. 9.

### (2) Step S102

If this frame is the broadcast frame, the frame rewriting section 113 checks whether or not this frame serves as the DHCP message.

### (3) Step S103

If this frame serves as the DHCP message, the frame rewriting section 113 refers to the access destination storage section 111 and checks whether or not the address data of the DHCP server is stored as the access destination address.

### (4) Step S105

If the address data of the DHCP server as the access destination address is determined not to be stored, the frame rewriting section 113 starts the access destination registration requesting process.

### (5) Step S106

If the address data of the DHCP server as the access destination address is stored, the frame rewriting section 113 checks whether or not a plurality of address data of the DHCP servers are stored.

### (6) Step S104

If the plurality of address data of the DHCP servers are not stored, namely, if there is only one address data of the DHCP server, the frame rewriting section 113 rewrites the destination address of the DHCP frame in accordance with the stored address data of the DHCP server. At this time, a process of setting the MAC address of the DHCP server for the Ethernet header and setting the IP address of the DHCP server for the IP address is executed. Also, the other fields such as the checksum are rewritten as necessary.

### (7) Step S107

If the plurality of address data of the DHCP servers are stored, the frame rewriting section 113 determines a buffer size on the basis of the number of the stored DHCP servers and carries out the allocation of at least one unicast frame buffer.

### (8) Step S108

Then, the frame rewriting section 113 generates at least one unicast frame for the allocated buffer so that the DHCP server serves as the destination in accordance with the address data of the DHCP server and the frame received by the frame receiving section 112. The generated unicast frame is transmitted by the frame transmitting section 114.

In the computer system in the second exemplary embodiment of the present invention, the plurality of DHCP servers are registered and the DHCP message is transmitted to one of the DHCP servers. Thus, even if any of the DHCP servers is failed or cannot be used because of its maintenance, any of the remaining DHCP servers can be used to carry out the DHCP process.

### Third Exemplary Embodiment

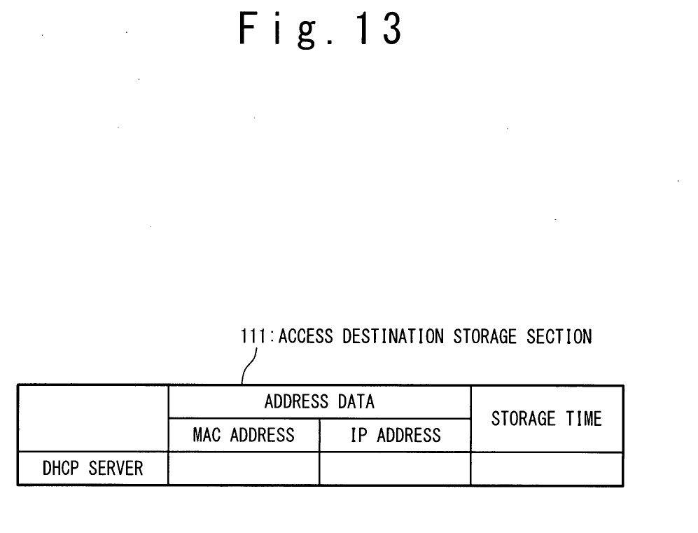

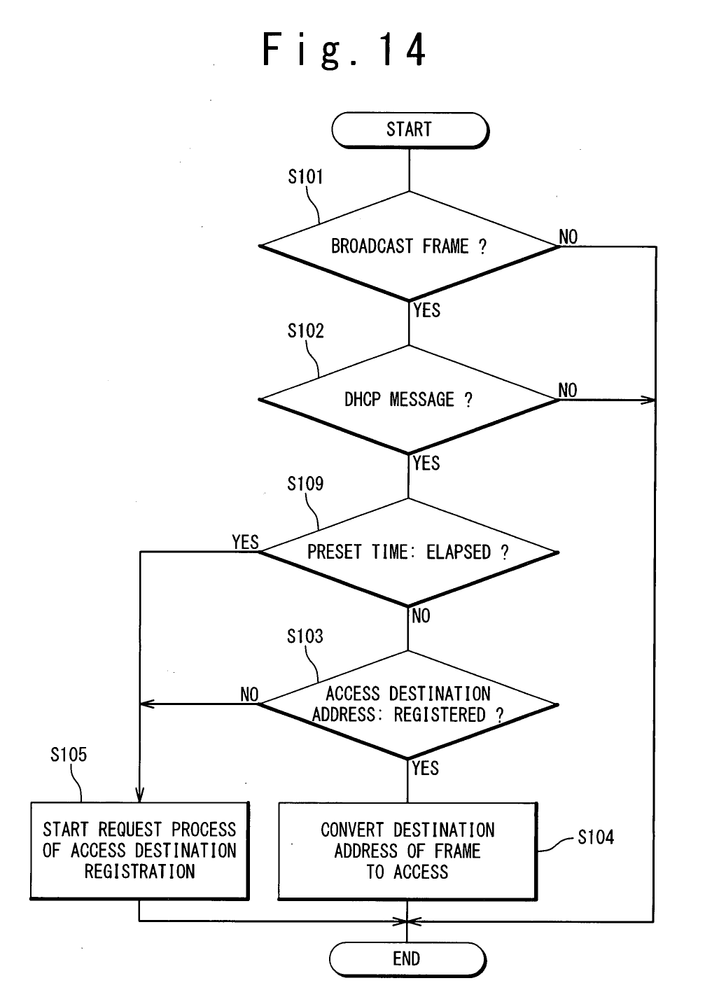

The configuration of the computer system according to a third exemplary embodiment of the present invention will be described below in detail with reference to the drawings. With reference to FIG. 13, the access destination storage section 111 records the address data of the DHCP server together with its storage time when it is stored. With reference to FIG. 14, the frame rewriting section 113 in the third exemplary embodiment executes a step S109 added to the flowchart of FIG. 8.

### (1) Step S101

When the frame transmitted from the virtual machine 120-1 is received by the frame receiving section 112, whether or not the frame is the broadcast frame is checked. This check is carried out by determining whether or not the destination address is the broadcast address in the DHCP message format shown in FIG. 9.

### (2) Step S102

If this frame is the broadcast frame, the frame rewriting section 113 checks whether or not this frame serves as the DHCP message.

### (3) Step S109

Even if this frame is determined to serve as the DHCP message, the frame rewriting section 113 keeps the broadcast state when a predetermined time elapses from the storage of the address data of the DHCP server. Then, the access destination registration requesting process is started.

### (4) Step S103

When this frame indicates the DHCP message and the predetermined time does not elapse from the storage of hen the address data of the DHCP server, the frame rewriting section 113 refers to the access destination storage section 111 and checks whether or not the address data of the DHCP server is stored as the access destination address.

### (5) Step S104

If the address data of the DHCP server is stored, the frame rewriting section 113 rewrites the destination address of the DHCP frame in accordance with the stored address data of the DHCP server. At this time, a process of setting the MAC address of the DHCP server for the Ethernet header and setting the IP address of the DHCP server for the IP address is executed. Also, the other fields such as checksum are rewritten as necessary.

### (6) Step S105

On the other hand, if the address data of the DHCP server as the access destination address is determined not to be stored, the access destination registration requesting process is started.

In the third exemplary embodiment of the present invention, the broadcast frame is transmitted for each constant time. Thus, even if the configuration of the DHCP server is changed, its change can be grasped at the timing when the broadcast frame is transmitted.

### Fourth Exemplary Embodiment

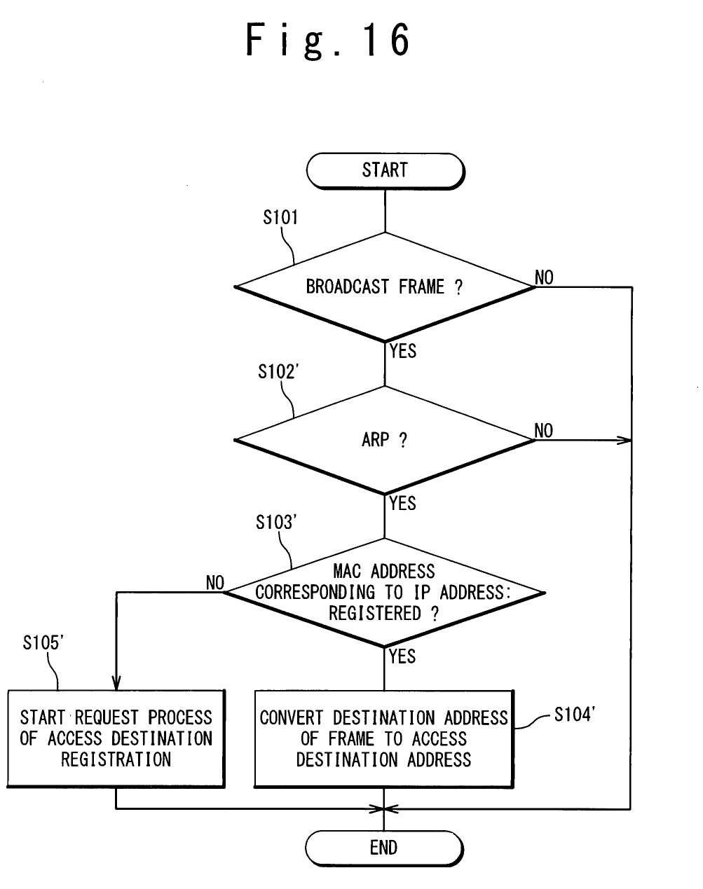

The configuration of the computer system according to a fourth exemplary embodiment of the present invention will be described below in detail with reference to the drawings. The fourth exemplary embodiment indicates the broadcasting process of the ARP. With reference to FIG. 16, the access destination storage section 111 serves as a table that can store an IP address and a MAC address corresponding thereto.

### (1) Step S101

With reference to FIG. 16, when the frame transmitted from the virtual machine 120-1 is received by the frame receiving section 112, whether or not the frame is the broadcast frame is checked. This check is carried out by determining whether or not the destination address is the broadcast address in the DHCP message format shown in FIG. 9.

### (2) Step S102′

In case of the broadcast frame, the frame rewriting section 113 in the fourth exemplary embodiment checks whether or not this frame is subject to ARP (Address Resolution Protocol).

### (3) Step S103′

When this frame is subject to ARP, the frame rewriting section 113 checks whether or not the MAC address of the IP address to be queried is already stored in the access destination storage section 111.

### (4) Step S104′

If it is already stored, the frame rewriting section 113 rewrites the destination address of the broadcast frame by using the MAC address.

### (5) Step S105′

On the other hand, if the MAC address of the IP address to be queried is not yet stored, the frame rewriting section 113 starts the access destination registration requesting process for the virtual machine transmitting the ARP broadcast frame.

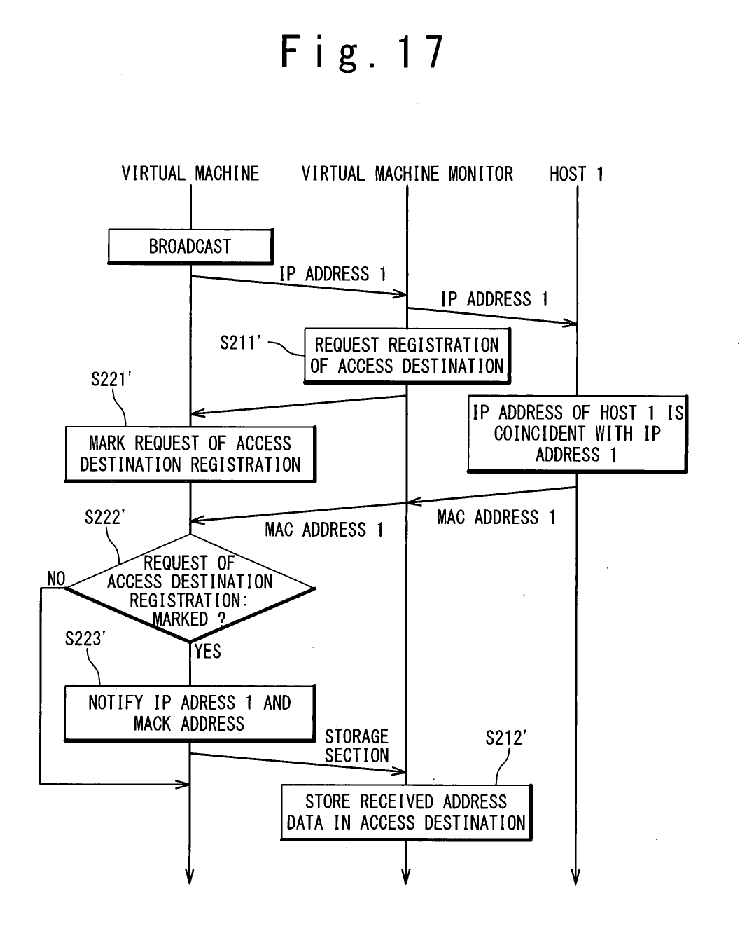

A flow of the access destination registration requesting process will be described below with reference to FIG. 17.

### (1) Step S211′

When starting the access destination registration requesting process at the Step S105′ of FIG. 16, the virtual machine monitor 110 issues the access destination registration request to the virtual machine 120-1 requesting the ARP broadcast.

### (2) Step S221′

The virtual machine 120-1 receives the access destination registration request and writes a mark to indicate that the access destination registration request has been received.

### (3) Step S222′

After that, the virtual machine 120-1 receives a MAC address 1 from the host having a queried IP address 1 and then checks whether or not the reception of the access destination registration request is marked.

### (4) Step S223′

If there is the mark, the IP address and the MAC address are notified to the virtual machine monitor 110.

### (5) Step S212′

The virtual machine monitor 110 stores this address data in the access destination storage section 111. In this case, similarly to the first exemplary embodiment, when the address data is stored in the access destination storage section 111, the registration request is issued to the virtual machine monitor 110, and the virtual machine monitor 110 carries out the registration in response to this request. However, when the virtual machine 120-1 may directly write the address data to the access destination storage section 111, if possible.

In the fourth exemplary embodiment of the present invention, even in case of the ARP, the broadcast can be suppressed, and the network load can be suppressed.

### Fifth Exemplary Embodiment

The configuration of the computer system according to a fifth exemplary embodiment of the present invention will be described below in detail with reference to the drawings. In the above-mentioned exemplary embodiments, the DHCP and the ARP are respectively treated to be single. However, in the fifth exemplary embodiment, both of the DHCP and the ARP are treated at the same time.

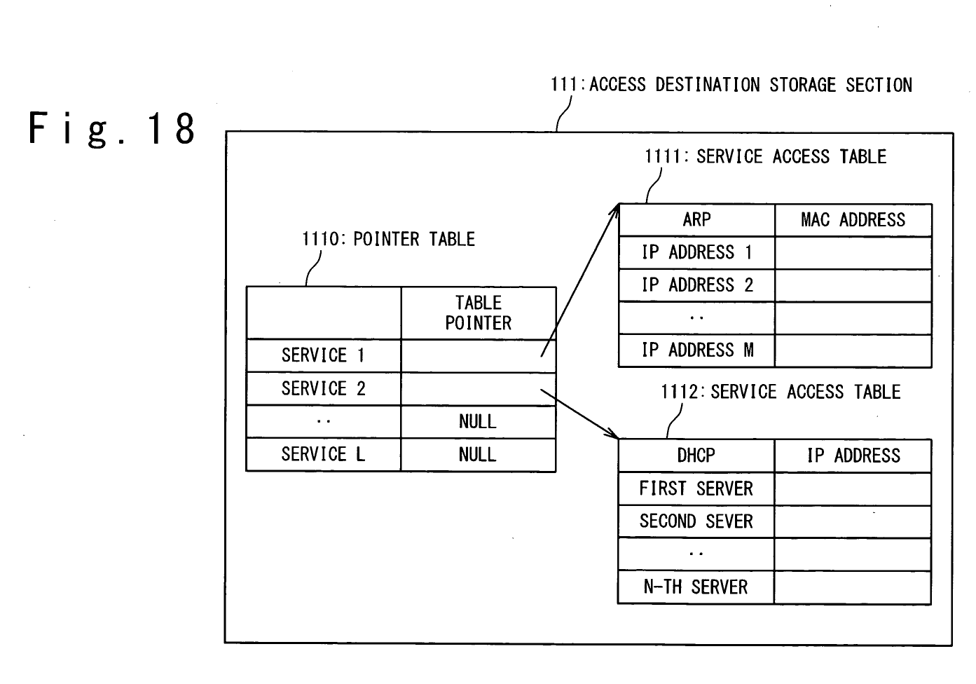

With reference to FIG. 18, the access destination storage section 111 has a pointer table 1110, a service access table 1111 and a service access table 1112. The pointer table 1110 stores pointers to the service access table 1111 and the service access table 1112. The service access table 1111 and the service access table 1112 store the access destinations for the services (ARP, DHCP and the like). Also, the service access table 1111 and the service access table 1112 store the data to identify the kind of the service altogether.

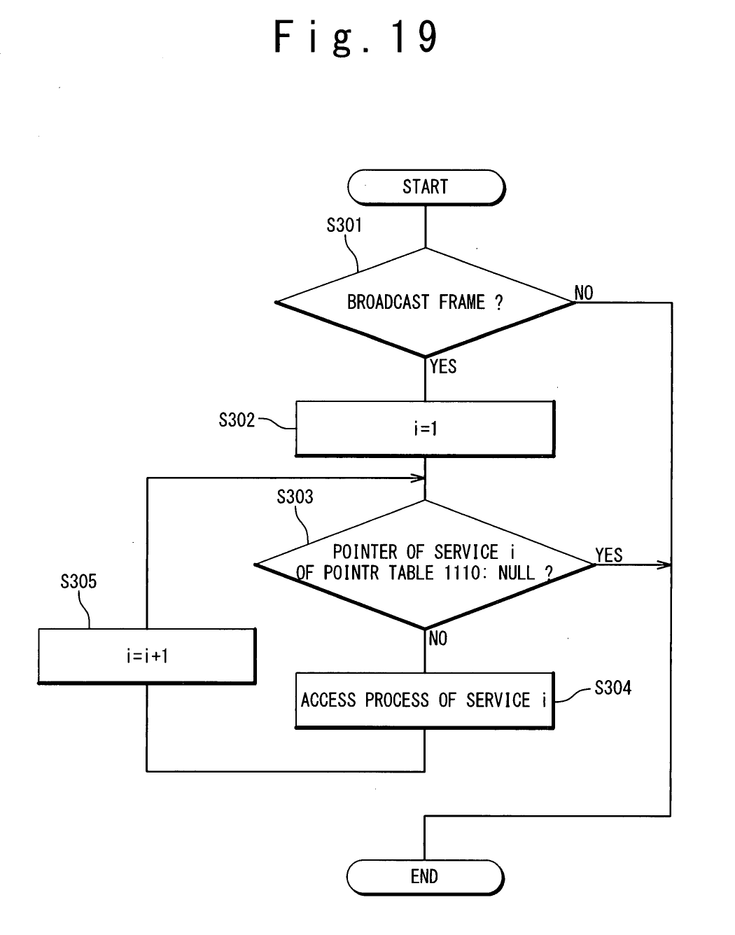

The operations of the computer system according to the fifth exemplary embodiment of the present invention will be described below with reference to FIG. 19.

### (1) Step S301

When a frame transmitted from the virtual machine 120-1 is received by the frame receiving section 112, whether or not its frame is the broadcast frame is checked.

### (2) Step S302

If the frame is a broadcast frame, the frame rewriting section 113 sets “1” to i.

### (3) Step S303

The frame rewriting section 113 checks whether or not the table pointer of the service i of the pointer table 1110 is NULL, and if the table pointer of the service i is NULL, the process is ended.

### (4) Step S304

The frame rewriting section 113 carries out an accessing process to the service i, if the table pointer of the service i is not NULL. However, its content is based on the DHCP or ARP and may be based on the above-mentioned first to fourth exemplary embodiments.

### (5) Step S305

After that, the frame rewriting section 113 adds “1” to i and checks whether or not the table pointer of the service i is NULL.

In the fifth exemplary embodiment of the present invention, a process of suppressing the broadcast can be performed on a plurality of services. Thus, the load on the network can be further reduced.

Moreover, according to the present invention, this can be widely applied to the process of searching the destination through the broadcast from the virtual machine.

It should be noted that the virtual machine 120 may be replaced by a physical machine. Even in such a case, the present invention can be embodied. That is, the virtual machine 120 may be the physical machine of a small scale or a function block that is installed in the physical machine 100. For example, if the physical machine 100 shown in FIG. 4 is defined as a computer that contains a processor for sending a frame, and a monitor for monitoring the frame sent by this processor, the present invention can be embodied. In this case, the processor corresponds to the virtual machine 120, and the monitor corresponds to the virtual machine monitor 110.

Also, it should be noted that the physical machine 100 is not limited to a computer terminal of a single unit, and this may be a network system such as LAN, which has a plurality of terminals. When the physical machine 100 is the network system, the present invention may be embodied such that the virtual machine 120 is used as the terminal inside the system and then the virtual machine monitor 110 is used as the monitor or relay of the terminal. At this time, when the terminal corresponding to the virtual machine 120 starts the operation as the virtual machine 120 on the physical machine 100, this is regarded and treated as [Generation of Virtual Machine 120]. Similarly, when the terminal completes the operation as the virtual machine 120, this is regarded and treated as [Removal of Virtual Machine 120].

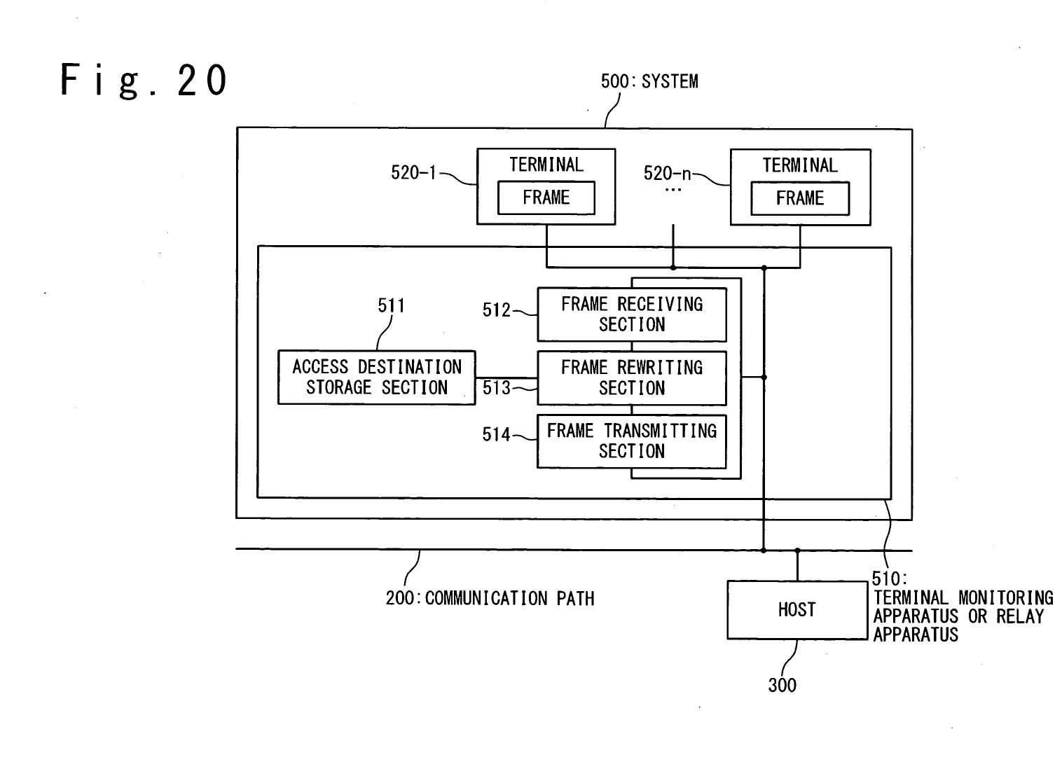

FIG. 20 is a block diagram showing the configuration of the computer system according to a sixth exemplary embodiment of the present invention. At this time, the computer system of the present invention contains a system 500, the communication path 200 and the host 300. The system 500 contains a terminal monitoring apparatus or a relay apparatus 510 and a terminal 520. The system 500 corresponds to the physical machine 100, the terminal monitoring apparatus or relay apparatus 510 corresponds to the virtual machine monitor 110, and the terminal 520 corresponds to the virtual machine 120, respectively. In this case, the terminal monitoring apparatus or relay apparatus 510 serves as a switch or router, and stores the destination data and then rewrites a necessary frame.

The features of the present invention have been described above. In the apparatus and method for reducing a communication load in the present invention, in the environment (hyper-visor) in which the VMs are used to integrate the plurality of clients, the DHCP server starts the VMs on the same hyper-visor. On the same LAN, there are the other clients and the other DHCP servers. In this way, the present invention is achieved in the following ways.

### (1) The client starts on the VM.

### (2) The client on the VM locally broadcasts a DHCP request and consequently requests an IP address.

### (3) The hyper-visor transmits a local broadcast frame of the DHCP to the DHCP server on the VM.

### (4) The DHCP server on the VM distributes the IP address to the client on the VM through unicast.

### (5) The hyper-visor sets the client on the VM having the IP address to the state connected to the LAN.

### (6) When the client on the VM is abnormally ended and the IP address is not normally released, the hyper-visor transmits a DHCP address release request to the DHCP server instead of it.

### (7) The hyper-visor does not transmit the DHCP request, which has been locally broadcasted by PC on the LAN, to each of VMs of a group thereon.

(8) In addition, when the client requests a service through the broadcast, similarly to a case of the DHCP server, the server providing the service operates on the VM of the same hyper-visor. Thus, the broadcast is replaced with the unicast.

As mentioned above, the present invention suppresses the broadcast from the virtual machine. For this reason, when the process request is carried out through the broadcast from the virtual machine on the physical machine, if the service request destination host is determined in advance, the broadcast is changed to the unicast to the host.

The useless broadcast can be avoided. Thus, the load on the network can be reduced. Also, the IP address group generated for the client group in the VM can be normally distributed.

Although the present invention has been described above in connection with several embodiments thereof, it will be apparent to those skilled in the art that those embodiments are provided solely for illustrating the present invention, and should not be relied upon to construe the appended claims in a limiting sense.

What is claimed is:

1. A computer system connected to a network, comprising:
a terminal apparatus configured to detect an access destination on the network, acquire a destination data of said access destination, and generate a frame having said destination data for said access destination; and
a monitoring apparatus configured to hold said destination data, and to produce at least one unicast frame to said access destination based on said destination data of said frame received from said terminal apparatus.

2. The computer system according to claim 1, wherein said monitoring apparatus issues an access destination registration request to said terminal apparatus, and acquires said destination data from said terminal apparatus, and
said terminal apparatus holds a data indicative of reception of said access destination registration request from said monitor apparatus and notifies said destination data to said monitoring apparatus if the data indicative of the reception of said access destination registration request is stored when receiving a reply from said access destination.

3. The computer system according to claim 1, wherein said monitoring apparatus comprises:
an access destination storage section configured to store an address data as said destination data;
a frame receiving section configured to receive said frame from said terminal apparatus and to confirm whether or not said frame is a predetermined message frame;
a frame rewriting section configured to rewrite said destination address of said unicast frame based on said address data which have been stored in said access destination storage section, when said frame is the predetermined message frame; and
a frame transmitting section configured to transmit said frame to said destination address.

4. The computer system according to claim 3, wherein said frame rewriting section confirms whether or not a plurality of said address data are stored, determines a size of a buffer based on a number of said address data, performs allocation of said buffer to said unicast frame, and produces said unicast frame in the allocated buffer by using the server corresponding to each of said address data as a destination based on said frame and said address data, and
said frame transmitting section transmits said unicast frame.

5. The computer system according to claim 3, wherein said frame rewriting section issues an access destination registration request without rewriting the destination address of said unicast frame when a preset time passes from a time when said address data is registered.

6. The computer system according to claim 3, wherein said frame rewriting section confirms whether a MAC address for an IP address to be inquired is held when said frame is ARP, and rewrites the destination address of said frame by use of said MAC address when said MAC address is possessed.

7. The computer system according to claim 3, wherein said frame rewriting section sets “1” to i when said frame is a preset frame, checks whether a table pointer of a service i of a pointer table is NULL, performs an access process of the service i, adds “1” to i and checks whether a table pointer of a service i of a pointer table is NULL.

8. The computer system according to claim 3, wherein said terminal apparatus is a virtual machine operating on a peripheral machine; and
said monitoring apparatus is a virtual machine monitoring apparatus.

9. A method of reducing a communication load, comprising:
acquiring a frame and confirming whether or not said frame is a predetermined message;
confirming whether or not address data of a server has been stored as an access destination address when said frame is the predetermined message;
rewriting a destination address of said frame by the address data of the server when the address data of the server is stored; and
starting an access destination registration requesting process when the address data of the server has not been stored as the access destination address.

10. The method according to claim 9, wherein said starting comprises:
issuing an access destination registration request when starting said access destination registration requesting process;
holding a data indicative of reception of said access destination registration request;
determining a server by receiving a reply from the server; and
confirming whether or not the data indicative of the reception of the access destination registration request is held;
acquiring the address data of the determined server when the data indicative of the reception of the access destination registration request is held; and
storing the address data of the determined server.

11. The method according to claim 9, wherein said rewriting comprises:
confirming whether or a plurality of address data for servers have been stored when the address data of the server has been stored as the access destination address;
rewriting a destination address of said frame with the stored address data of the server when one address data of the server has been stored;
determining a buffer size based on the number of the address data and allocating at least one unicast frame buffer, when a plurality of address data of the servers have been stored;
producing said unicast frame in a buffer allocated to have the server as a destination based on the address data of said frame; and
transmitting said unicast frame by a frame transmitting section.

12. The method according to claim 9, wherein said confirming whether or not address data of a server has been stored as an access destination address comprises:
when determining that said frame is a predetermined message but a preset time passes from a time when the address data of the server is stored, starting the access destination registration requesting process without rewriting the destination address of said frame.

13. The method according to claim 9, further comprising:
checking whether or not said frame is ARP;
checking whether or not a MAC address for an IP address to be inquired is already stored when said frame is ARP; and
rewriting the destination address of said unicast frame with said MAC address when said MAC address is already stored,
wherein said starting comprises:
starting the access destination registration requesting process to a terminal which has transmitted said ARP frame when said MAC address is not stored.

14. The method according to claim 9, further comprising:
setting 1 to i;
checking whether or not a table pointer of the service i of a pointer table is NULL;
ending a process if the table pointer of service i is null NULL;
adding 1 to i after carrying out an access process to the service i if the table pointer of service i is not NULL; and
checking whether or not the table pointer of service i is NULL.

15. A computer-readable software product for realizing a method of reducing a communication load, wherein said method comprises:
acquiring a frame and confirming whether or not said frame is a predetermined message;
confirming whether or not address data of a server has been stored as an access destination address when said frame is the predetermined message;
rewriting a destination address of said frame by the address data of the server when the address data of the server is stored; and
starting an access destination registration requesting process when the address data of the server has not been stored as the access destination address.

16. The computer-readable software product according to claim 15, wherein said starting comprises:
issuing an access destination registration request when starting said access destination registration requesting process;
holding a data indicative of reception of said access destination registration request;
determining a server by receiving a reply from the server; and
confirming whether or not the data indicative of the reception of the access destination registration request is held;
acquiring the address data of the determined server when the data indicative of the reception of the access destination registration request is held; and
storing the address data of the determined server.

17. The computer-readable software product according to claim 15, wherein said rewriting comprises:
confirming whether or a plurality of address data for servers have been stored when the address data of the server has been stored as the access destination address;
rewriting a destination address of said frame with the stored address data of the server when one address data of the server has been stored;
determining a buffer size based on the number of the address data and allocating at least one unicast frame buffer, when a plurality of address data of the servers have been stored;
producing said unicast frame in a buffer allocated to have the server as a destination based on the address data of said frame; and
transmitting said unicast frame by a frame transmitting section.

18. The computer-readable software product according to claim 15, wherein said confirming whether or not address data of a server has been stored as an access destination address comprises:
when determining that said frame is a predetermined message but a preset time passes from a time when the address data of the server is stored, starting the access destination registration requesting process without rewriting the destination address of said frame.

19. The computer-readable software product according to claim 15, wherein said method further comprises:
checking whether or not said frame is ARP;
checking whether or not a MAC address for an IP address to be inquired is already stored when said frame is ARP; and
rewriting the destination address of said unicast frame with said MAC address when said MAC address is already stored,
wherein said starting comprises:
starting the access destination registration requesting process to a terminal which has transmitted said ARP frame when said MAC address is not stored.

20. The computer-readable software product according to claim 15, wherein said method further comprises:
setting 1 to i;
checking whether or not a table pointer of the service i of a pointer table is NULL;
ending a process if the table pointer of service i is null NULL;
adding 1 to i after carrying out an access process to the service i if the table pointer of service i is not NULL; and
checking whether or not the table pointer of service i is NULL.
